(19) United States
(12) Patent Application Publication
(10) Pub. No.: US 2011/0164941 A1
(43) Pub. Date: Jul. 7, 2011

(54) Fastener Device

(76) Inventor: Robert T. Snead, Montrose, CO (US)

(21) Appl. No.: 12/673,659

(22) PCT Filed: Aug. 18, 2008
(86) PCT No.: PCT/US08/73524

§ 371 Date: Mar. 21, 2011

Related U.S. Application Data
(60) Provisional application No. 60/956,344, filed on Aug. 16, 2007.
(60) Provisional application No. 60/980,151, filed on Oct. 15, 2007.
(60) Provisional application No. 60/982,311, filed on Oct. 24, 2007.

(51) Int. Cl. F16B 21/06; F16B 33/00

(52) U.S. Cl. 411/340

(57) ABSTRACT

A fastener device making a single hole to attach an item, providing a bolt, a nut and a toggle having a hollow cylindrical body with opposite U-shaped openings forming an aperture to pivot the toggle into a toggle first condition with coplanar body and bolt longitudinal axis or into a toggle second condition with perpendicular body and bolt longitudinal axis.

### CROSS-REFERENCE TO RELATED APPLICATIONS

Provisional Application Number 605956344 filed Aug. 16, 2007, Provisional Application Number 60980151 filed Oct. 15, 2007, Provisional Application Number 60982311 filed Oct. 24, 2007 and PCT Application Number PCT/US08/73524 Filed Aug. 18, 2008.

### FEDERALLY SPONSORED RESEARCH OR DEVELOPMENT

Not Applicable

### INCORPORATION BY REFERENCE OF MATERIAL SUBMITTED ON A COMPACT DISK

Not Applicable

### BACKGROUND OF THE INVENTION

Installation of wall standards and other items often requires the use of mechanical fasteners. Fasteners of this type are generally referred to as “hollow wall” anchors and are typically used to attach items to drywall in the absence of wood or steel backing. The primary type of fastener used in the past has been the “toggle bolt” type. Installation of the toggler type of fastener requires a multiple step process, which can be quite timely and very frustrating. The typical toggle bolt type installation requires first marking the desired fastener location, drilling a hole to receive the toggle bolt, inserting the toggle bolt and finally installing the attachment screw or bolt through the item being attached into the toggle bolt and then tightening. The problem of using a typical “toggle” type fastener is exacerbated when additional fasteners cannot be installed without first removing the item being attached to drill additional holes and install an additional “toggler” before being able to install additional screw or bolts. The typical “toggle” type fastener cannot be installed from the front of the object being attached and even anchors of the small plastic type must first be installed behind the item being attached. The present fastener device addresses installation difficulties encountered using other toggle types by permitting installation of a mechanical anchor from the front of the item through a single attachment hole, which results in a hole no larger in diameter than the diameter of the toggle itself and provides a strong mechanical attachment, which is less likely to loosen than previous typical toggle type fasteners.

### SUMMARY OF THE INVENTION

The present fastener device is a mechanical anchor which is installed from the front of an item and which passes through a single hole to provide a solid, strong mechanical attachment to drywall. The present device provides several types of fastener devices. All fastener device types provide a bolt, which may be a threaded combination round head screw or an eye bolt, and threaded nut, a toggle having a cylindrical body and a hollow interior, which pivots around and fits over the bolt, and means for selectively securing the cylindrical body in one of two positions. The toggle has a U-shaped opening on opposite sides, each opening have a rounded apex portion together forming a circular aperture through the toggle center diameter which pivotally engages the bolt. A toggle first condition is where the longitudinal axis of the cylindrical body is coplanar to the longitudinal axis of the bolt and a toggle second condition is where the longitudinal axis of the cylindrical body is perpendicular to the longitudinal axis of the bolt. Variations of the device may provide at least one torus-shaped O-ring. The first type provides a pair of O-rings with each O-ring engaging the bolt on an opposite side of the toggle. Each O-ring assists in pushing the toggle through the drywall and allow the toggle to open perpendicularly to the bolt after drilling. The second type of fastener device has a single O-ring, a nut with a parallelepiped protrusion which fits into the toggle, and length of semi-flexible foam material inserted into at least one of the U-shaped toggle openings to assist in seating the toggle against the threads of the bolt while drilling the bolt through the drywall. The third type provides a modified nut having a top edge with a single crescent-shaped notch to secure the toggle in closed position while drilling the fastener device into the drywall and a single O-ring. The fourth type provides a modified nut having a top edge with crescent-shaped notches on opposite sides the top edge to capture the toggle in a desired position. The fourth type further provides a single O-ring and a washer to capture and prevent the toggle from opening during installation. The present device also provides a cap that has a threaded shank end which threadingly engages the bolt bottom end and an opposite cutter end which operationally engages a drill bit, which may have a Phillips tip, the cap having the same diameter as the toggle. The components of the foregoing types of fastener devices may be combined to form other types of fastener devices.

As such, the general purpose of the improved fastener device which has all of the advantages of the prior art mentioned heretofore and many novel features that result in an improved fastener device which is not anticipated, rendered obvious, suggested, or even implied by the prior art, either alone or in combination thereof.

Thus has been broadly outlined the more important features of the improved fastener device so that the detailed description thereof that follows may be better understood and in order that the present contribution to the art may be better appreciated.

The objects, features and advantages of the improved fastener device will be readily apparent to those of ordinary skill in the art upon reading the following detailed description of presently preferred, but nonetheless illustrative, embodiments of the improved fastener device when taken in conjunction with the accompanying drawings. In this respect, before explaining the current embodiments of the improved fastener device in detail, it is to be understood that the invention is not limited in its application to the details of construction and arrangements of the components set forth in the following description or illustration. The invention is capable of other examples and of being practiced and carried out in various ways. It is also to be understood that the phraseology and terminology employed herein are for purposes of description and should not be regarded as limiting.

Those skilled in the art will appreciate that the concept of this disclosure may be readily utilized as a basis for the design of other structures, methods, and device for carrying out the several purposes of the improved fastener device. It is therefore important that the claims be regarded as including such equivalent constructions insofar as they do not depart from the spirit and scope of the present invention.

Objects of the improved fastener device, along with various novel features that characterize the invention are particularly pointed out in the claims forming a part of this disclosure. For better understanding of the improved fastener device, its operating advantages and specific objects attained by its uses, refer to the accompanying drawings and description.

### BRIEF DESCRIPTION OF THE DRAWINGS

FIG. 1 is a top plan view with toggle in open position.

FIG. 2 is a front isometric view with toggle in open position.

FIG. 3 is a rear isometric view with toggle in open position.

FIG. 4 is a right side elevation with toggle in open position.

FIG. 5 is a right side elevation with toggle in closed position.

FIG. 6 is a left side elevation with toggle in closed position.

FIG. 7 is a top plan view with toggle in open position.

FIG. 8 is a front elevation view with toggle in open position.

FIG. 9 is a top isometric view with toggle in closed position.

FIG. 10 is a side elevation view with toggle in open position.

FIG. 11 is a top plan view illustrating a nut capturing a toggle in open position.

FIG. 12 is a side elevation view of a modified nut.

FIG. 13 is an isometric view of another modified nut.

FIG. 14 is a top plan view with a toggle in open position.

FIG. 15 is a front elevation view of a cap.

FIG. 16 is an isometric view of the device utilizing an eye bolt.

### DETAILED DESCRIPTION OF THE DRAWINGS

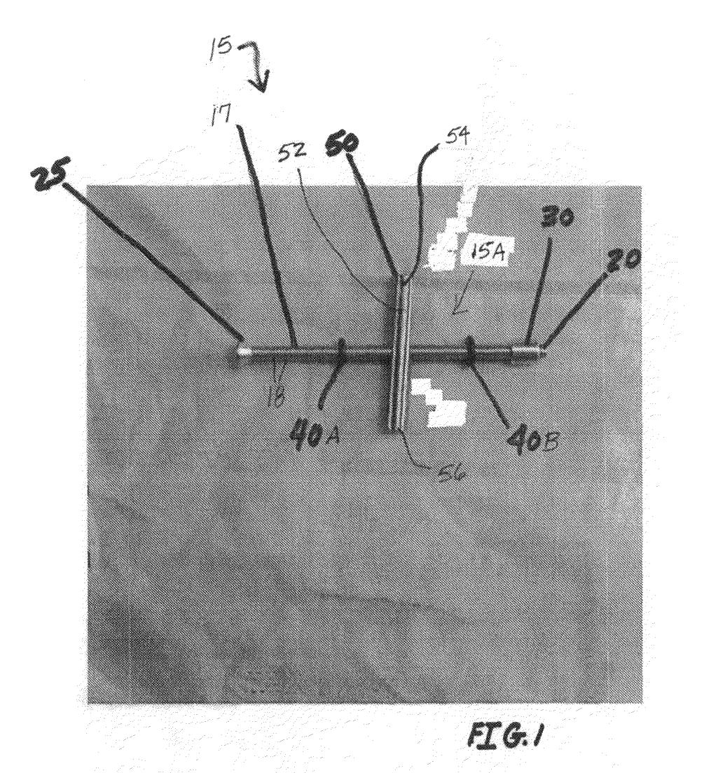

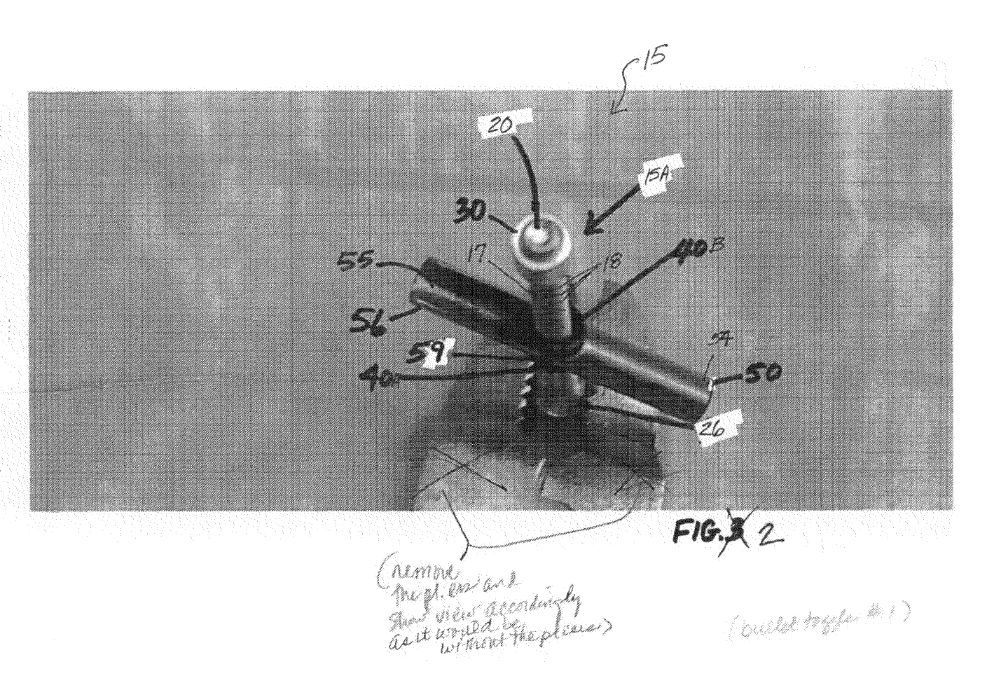

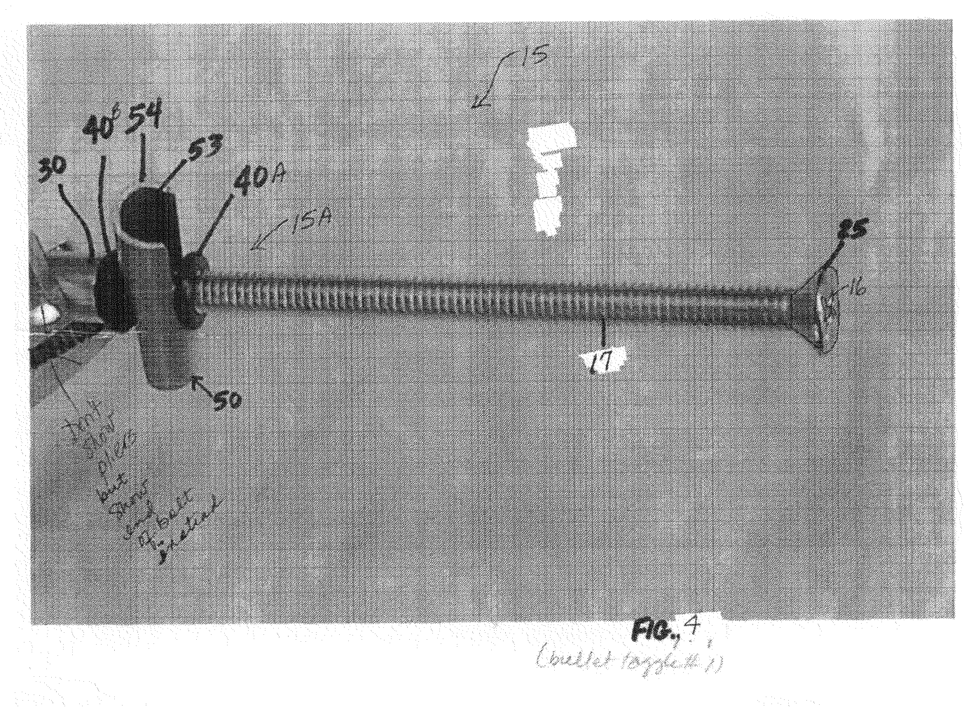

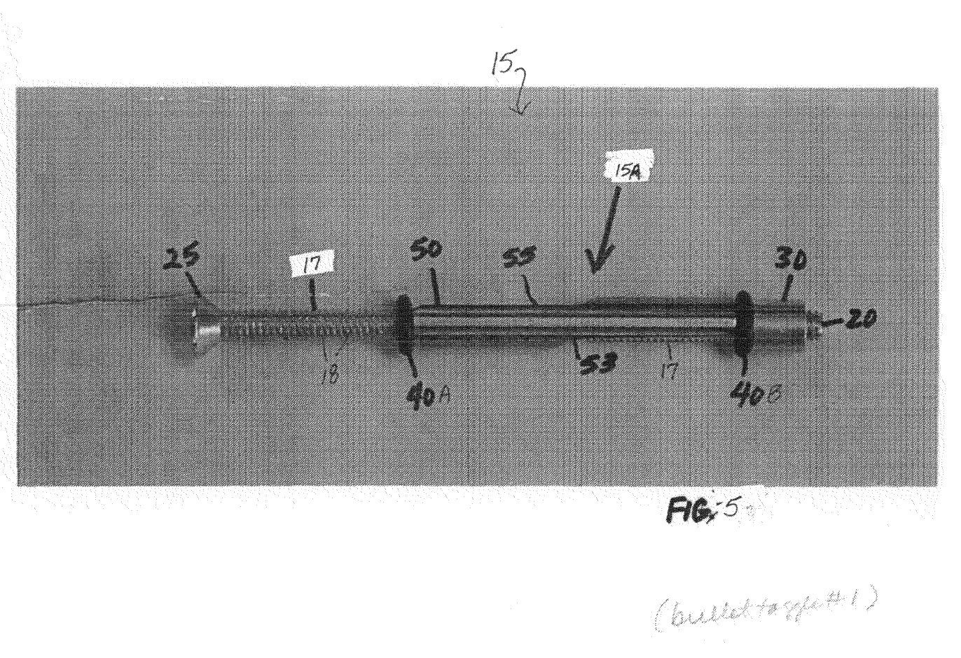

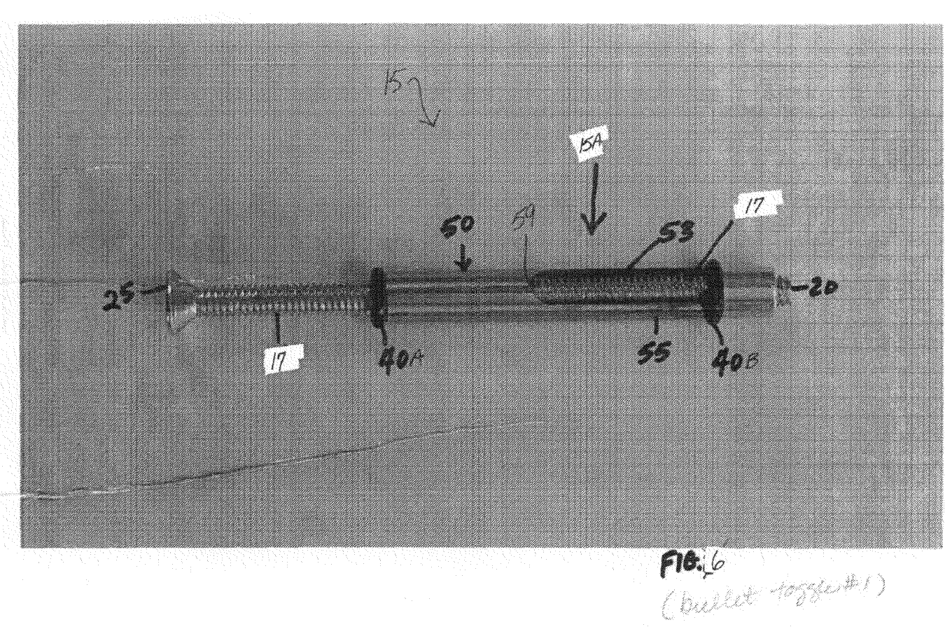

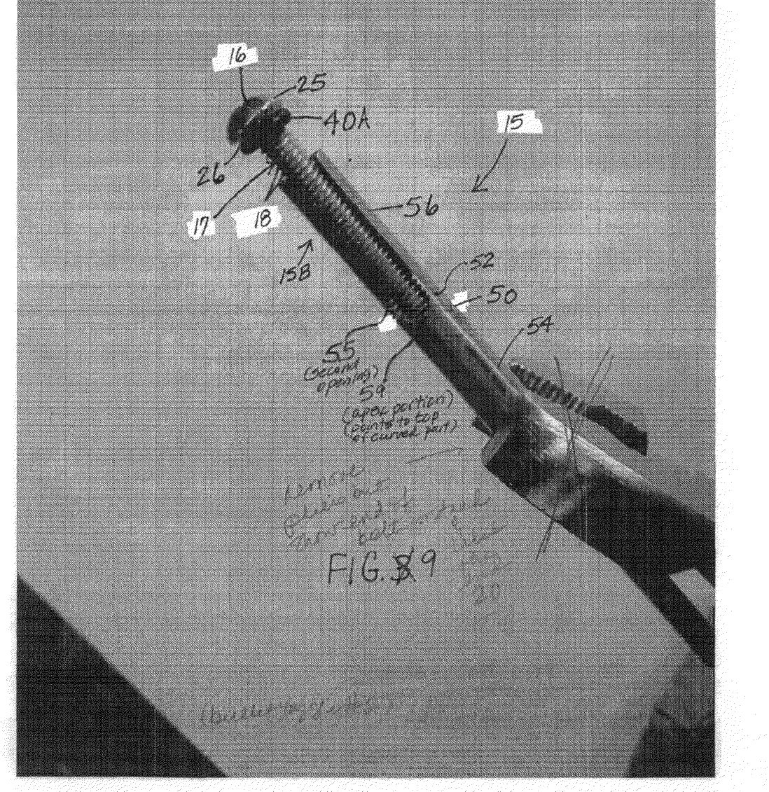

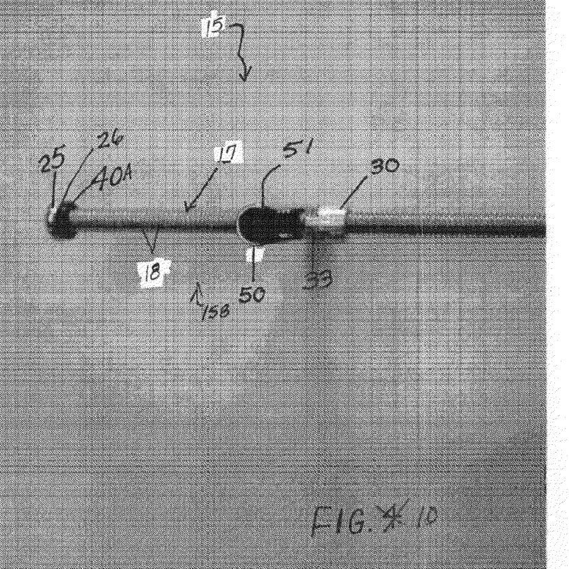

With reference now to the drawings, and in particular FIGS. 1 through 16 thereof, examples of the employing the principles and concepts of the present fastener device, generally designated by the reference number 15, will be described.

The present fastener device 15 is a mechanical anchor installed from the front of an item for attachment to drywall, the fastener device 15 passing through a single hole and providing a solid mechanical attachment to the wall. The device 15 provides several types of fastener devices 15A, 15B, 15C, and 15D.

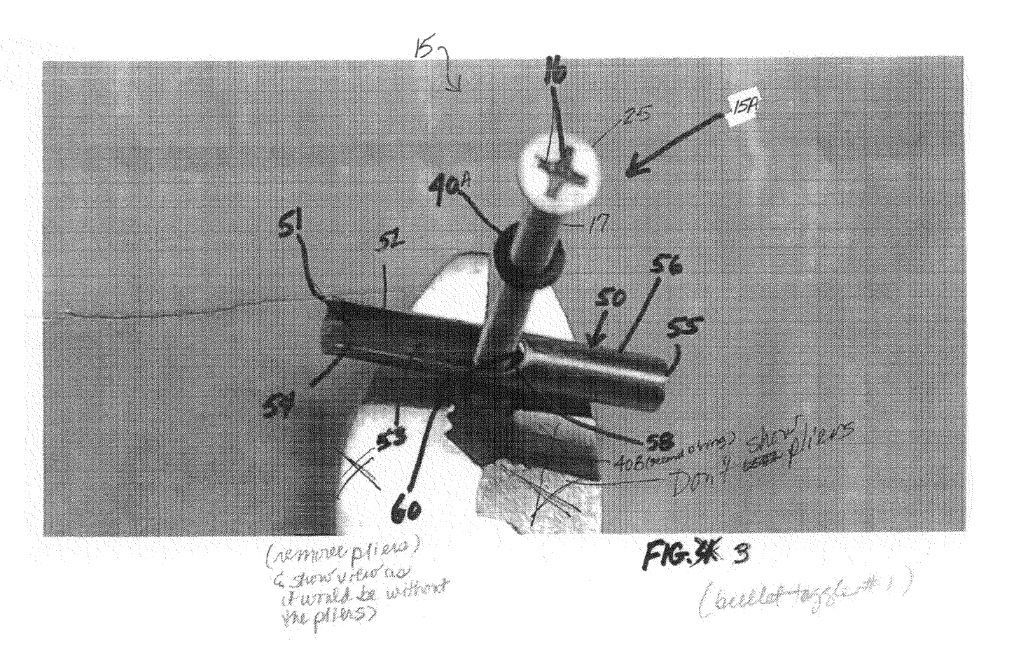

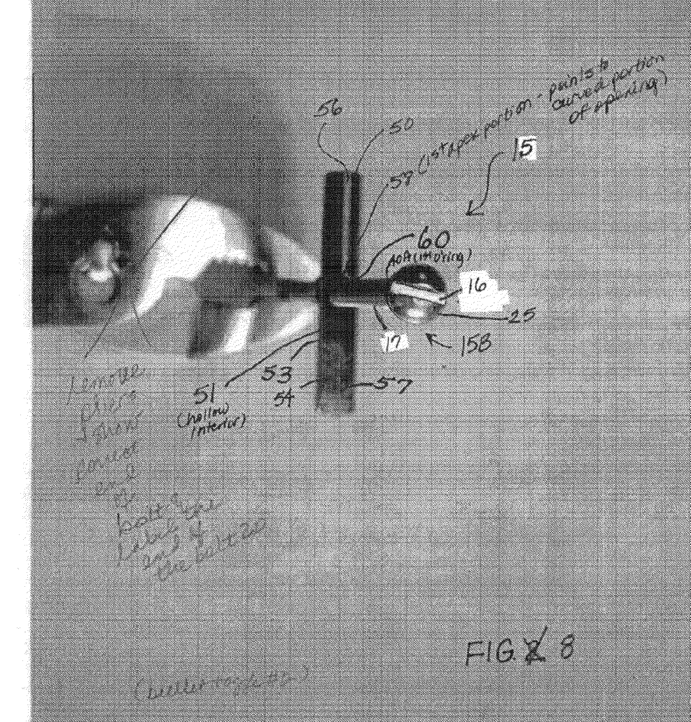

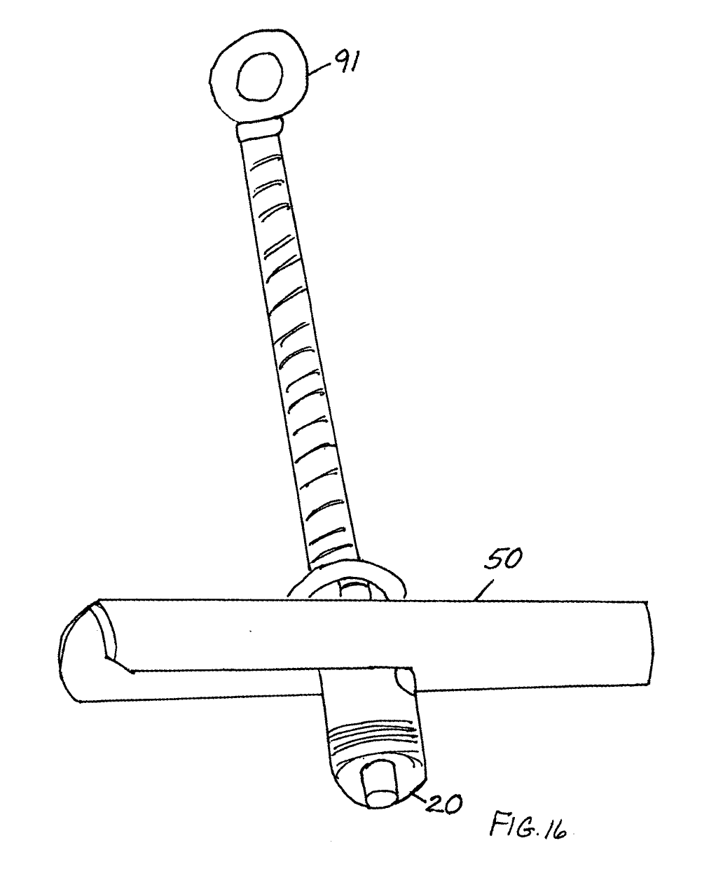

All variations of the device 15A, 15B, 15C, and 15D provide a bolt 17 having a bottom end 20 and a head end 25 and which may further have threads 18, a toggle 50, and a nut 30. The bolt 17 head end 25 may have indentations 16, positioned in a cross-like configuration, as shown in FIG. 3, to operationally engage the end of a Phillips screwdriver or in a solitary straight configuration to operationally engage the end of a straight-slot type screwdriver, as shown in FIG. 8. In addition, the bolt 17 may be a combination round head screw or an eye bolt as illustrated in FIG. 16. The toggle 50 has a cylindrical body 52 less than the bolt length, a diameter slightly greater than the diameter of the bolt 17, and a hollow interior 51. The diameter of the toggle 50 is slightly greater than the bolt 17 diameter to accommodate pivoting of the toggle 50 to permit the bolt 17 to pass through the toggle 52 interior 51. The body 52 has a first end 54 and a second end 56. The first end 54 has a U-shaped first opening 53 running continuously along one side of the body 52. The first opening 53 has a rounded first apex portion 58. The second end 56 has a second opening 55 running continuously along the opposite side of the body 52 from the first opening 53. The second end 56 has a rounded second apex portion 59. The second opening 55 continuously runs along the opposite side of the length of the body 52 second end 56 on the opposite side of the toggle 50. The first apex portion 58 and the second apex portion 59 form an aperture 60 through the center diameter of the body 52. The aperture 60 pivotally engages the bolt 17 thereby allowing the toggle 50 to fit over the bolt 17. There is a toggle first condition wherein the longitudinal axis of the cylindrical body 52 is coplanar to the longitudinal axis of the bolt 17. There is a toggle second condition wherein the longitudinal axis of the cylindrical body 52 is perpendicular to the longitudinal axis of the bolt 17. The nut 30, which may be threaded, selectively engages the cylindrical body 52 in the toggle first condition with the nut 30 located on the bottom end 20 of the bolt 17. In the toggle first condition, the bolt 17 completely passes through the toggle 50 interior 51. Various means for selectively securing the cylindrical body 52 in a toggle first position located between the head end 25 of the bolt 17 and the cylindrical body 52.

The toggle 50 is secured in the toggle first position while drilling of the device 15 into drywall or other surface. The toggle second position secures the device 15 to the drywall or other surface

Each of the first type 15A, second type 15B, third type 15C and fourth type 15D of fastener device 15 has a means for selectively securing the cylindrical body in a toggle first condition located between the head end of the bolt and the cylindrical body. The first type 15A of fastener device 15, shown in FIGS. 1 through 6, provides means for selectively securing the cylindrical body in a toggle first position including a first O-ring 40A, a second O-ring 40B, each O-ring 40A, 40B engaging the bolt 17 on an opposite side of the toggle 50. The O-rings 40A, 40B, which may be torus-shaped, assist in pushing the toggle 50 through the drywall during drilling. Each O-ring 40A, 40B fits loosely against the toggle 50 to permit the toggle 50 to pivot into an open position in which the toggle 50 is positioned perpendicularly to the bolt 15 after drilling is completed.

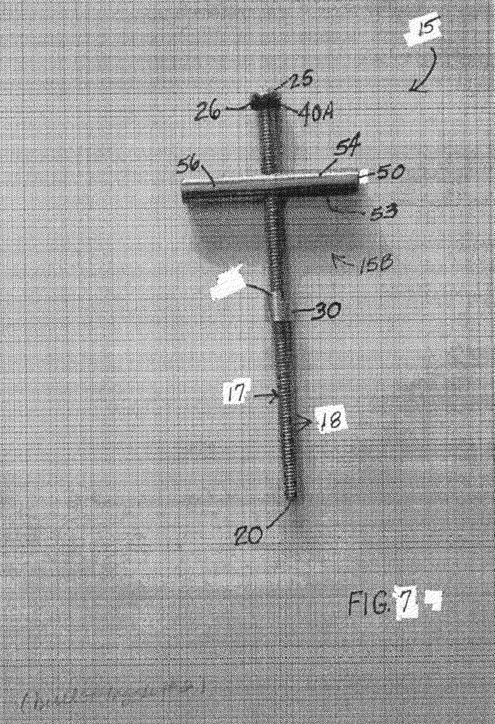

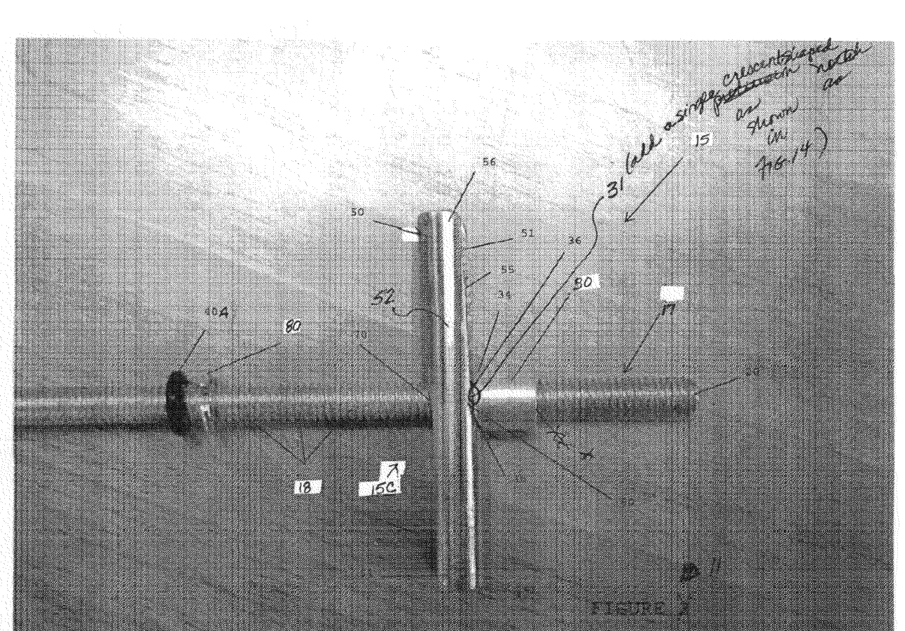

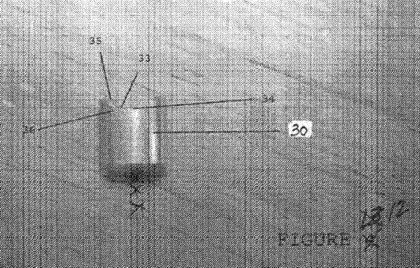

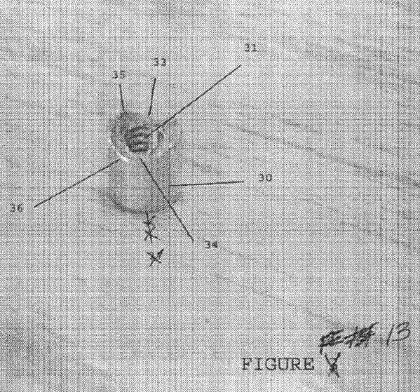

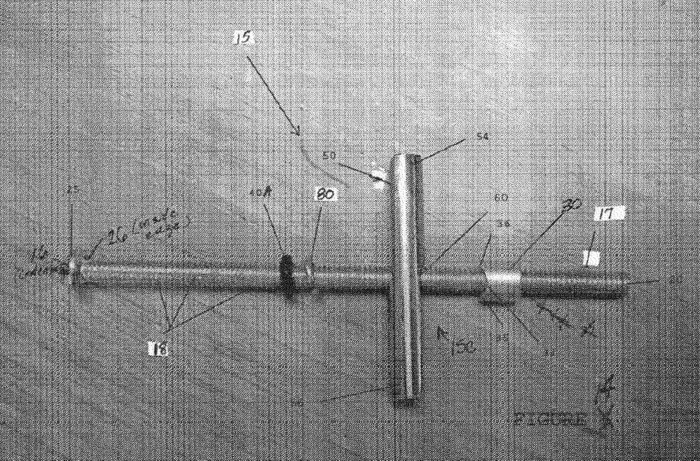

In the second type 15B, shown in FIGS. 7 through 10, the means for selectively securing the cylindrical body in a toggle first position provides only a first O-ring, as well as a length of foam material 57 and a modified nut 30 having a parallelepiped protrusion 33. The nut 30 and first O-ring 40A engage the bolt 17 on opposite sides of the toggle 50 with the first O-ring 40A nearer the bolt 17 head 25. The nut 30 protrusion 33 slidingly engages at least one of U-shaped openings 53, 55 to temporarily secure the toggle 50 into closed position during drilling of the device 15 into drywall. The foam material 57 inserts into at least one of the U-shaped openings 50 as illustrated in FIG. 8 to seat the toggle 50 against the threads of the bolt 17 during drilling of the device 15 into drywall. In the third type 15C, shown in FIGS. 11 and 12, the means for selectively securing the cylindrical body in a toggle first condition is the first O-ring 40A and a modified nut 30 having a single crescent-shaped first notch 33, rather than a protrusion 31. The first O-ring 40A and nut 30 engage the bolt 17 on opposite sides of the toggle 50. In the fourth type 15D, shown in FIGS. 13 and 14, the means for selectively securing the cylindrical body in a toggle first position is the first O-ring, a nut 30 modified to have a crescent-shaped first notch 33 and an identical second notch 34, instead of a protrusion 31, on a first top edge 35 and an opposite second top edge, 36 respectively, along with a washer 80. The nut 30 crescent-shaped notches 33, 34 of the nut 30 temporarily secure the toggle 50 in a closed position while drilling the device 15 into drywall. The washer 80 and the first O-ring 40A slidingly engage the bolt 17 on an opposite side of the toggle 50 from the nut 30 and with the first O-ring 40A positioned nearer the bolt 17 than the washer 80. The diameter of the nut 30, the first O-ring 40A, the second O-ring 40B, and the washer 80 is about the same as the diameter of the toggle 50.

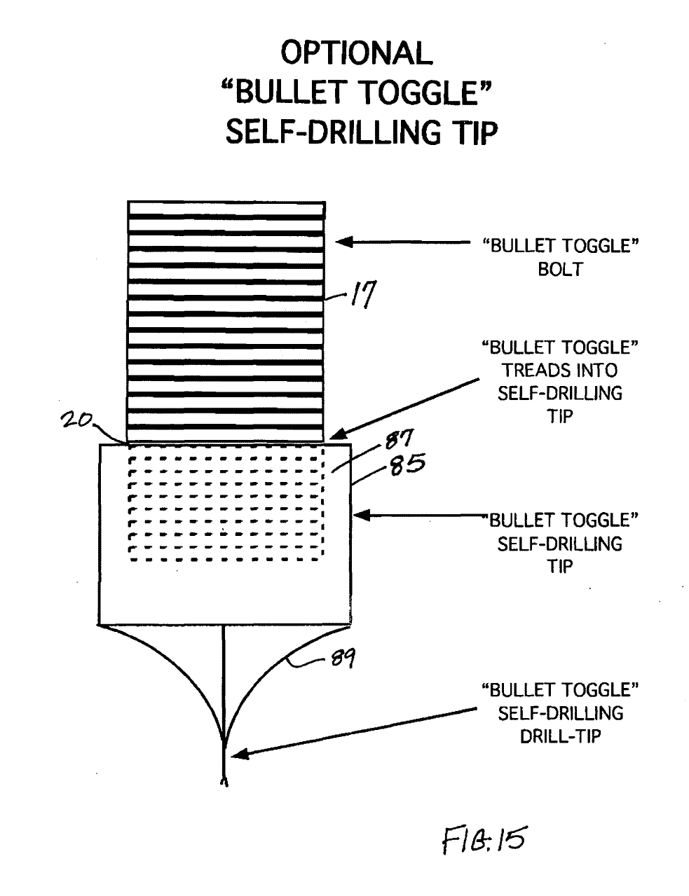

The present device 15 also provides a cap 85, shown in FIG. 15, that has a threaded shank end 87 which threadingly engages the bolt bottom end 20 and an opposite cutter end 89 which operationally engages a drill bit, which may have a Phillips tip, the cap 85 having the same diameter as the toggle 50.

The bolt 17, nut 30, toggle 50, and washer 80 may be formed of metal construction. The first O-ring 40A and second O-ring 40B may be formed of rubber. The components of the foregoing types of fastener devices may be combined to form other types of fastener devices.

### Operation:

To use the third type 15C of fastener device 15, a user slidingly engages a single first O-ring 40A on the bolt 17. The first O-ring 40 is selectively positioned along the length of the bolt 17 at a minimum distance from the bolt 17 head 25 to allow the device 15 to be inserted into the drywall with bolt 17 head 25 flush against the drywall. Next, the user slides the toggle 50 onto the bolt 17 by sliding the bolt 17 through the toggle 50 aperture 60. The toggle 50 is then pivoted into a closed position in which the bolt 17 completely passes through the toggle 50. One of the toggle 50 first end 54 and second end 56 are selectively semi-loosely fitted against the first O-ring 40A. Then, a nut 30 having a first notch 33 is threaded onto the bolt 17 with the first notch 33 selectively engaging the first opening 53 or the second opening. Next, with the toggle 50 in a closed position, the device 15 is drilled through the front of the item, which may include a wall hanging, towel bars, wall cabinets, a mirror, to be secured to the drywall and through the drywall. Then, the toggle 50 opens on the back side of the drywall, thereby creating a hole no larger in diameter than the diameter of the toggle 50. A user then tightens the fastener device 15C with a screwdriver to secure the toggle 50 body 52 flat against the back side of the drywall and the bolt 17 head 25 flush against the exterior of the drywall.

To use the first type 15A of device 15, a first O-ring 40 is placed on the bolt 17. Next the user slides the toggle 50 onto the bolt 17. Then, the toggle 50 is pivoted into a closed position in which bolt 17 completely passes through the toggle 50. Then one of the toggle 50 first end 54 or second end 56 is semi-loosely fitted against the first O-ring 40A. Then, a second O-ring 40B is slipped onto the bolt 17 and is semi-loosely fitted against the opposite toggle 50 first end 54 or second end 56. Next, with the toggle 50 in closed position, the fastener device 15 first type 15A is drilled through the front of the item to be secured to the drywall and through the drywall. Then, the toggle 50 opens on the back side of the wall. The user then tightens the fastener device 15A with a screwdriver to secure the toggle 50 body 52 flat against the back side of the drywall.

To use the second type 15B of fastener device 15, a user slides a first O-ring 40A onto the bolt 17. Next, the user slides a toggle 15 onto the bolt 17 by placing the bolt 17 through the toggle 50 aperture 60. Then, the toggle 50 is pivoted into a closed position in which the bolt 17 completely passes through the toggle 50. One of the toggle 50 first end 54 or second end 56 is semi-loosely fitted against the first O-ring 40A. Then, a nut 30 is threaded onto the bolt 17 with the protrusion 31 selectively engaging one of the first opening 53 or the second opening 55, opposite the first O-ring 40A. Then, a user drills the device 15, with the toggle 50 in a closed position, through the front of an item to be secured to the drywall and through the drywall. Then, the toggle 50 opens on the back side of the drywall. A user then tightens the second type 15B of fastener device 15 with a screwdriver to secure the toggle 50 body 52 flat against the back side of the drywall.

To use the fourth type 15C of fastener device 15, a user slides a first O-ring 40 onto the bolt 17. Then, the user slides a toggle 15 onto the bolt 17 by placing the bolt 17 through the aperture 60 of the toggle 15. Next, the toggle 50 is pivoted into a closed position in which bolt 17 passes completely through the toggle 50. One of the toggle first end 54 and second end 56 is selectively semi-loosely fitted against the first O-ring 40A. Then, a nut 30 is threaded onto the bolt 17 with the first notch 33 and second notch 34 selectively engaging the first opening 53 and the second opening 55. A user then drills the device 15, with the toggle in closed position, through the front of an item to be secured to drywall and through the drywall. The toggle 50 then opens on the back side of the drywall. A user then tightens the fastener device 15 with a screwdriver to secure the toggle 50 body 52 flat against the back side of the drywall and the bolt 17 head 25 flush against the exterior side of the drywall.

To use the cap 85, shown in FIG. 15, the user threads the shank end 87 onto the bolt bottom end 20 and engages a drill bit into the cutter end 89 to drill the device 15 into a wall.

With respect to the above description then, it is to be realized that the optimum dimensional relationships for the parts of the present device, to include variations in size, materials, shape, form, function and the manner of operation, assembly and use, are deemed readily apparent and obvious to one skilled in the art, and all equivalent relationships to those illustrated in the drawings and described in the specification are intended to be encompassed by the present invention.

Directional terms such as “front”, “back”, “in”, “out”, “downward”, “upper”, “lower”, and the like may have been used in the description. These terms are applicable to the examples shown and described in conjunction with the drawings. These terms are merely used for the purpose of description in connection with the drawings and do not necessarily apply to the position in which the present invention may be used.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed is:

1. A fastener device comprising, in combination:
a bolt having a bottom end and a head end;
a toggle having a cylindrical body less than the bolt length, a diameter slightly greater than the diameter of the bolt, and a hollow interior, the body further comprising:
a first end having a U-shaped first opening running continuously along one side of the body, the first opening having a rounded first apex portion, and
a second end having a U-shaped second opening running continuously along the opposite side of the body from the first opening, the second opening having a rounded second apex portion;
the first apex portion and second apex portion forming an aperture through the center diameter of the body, the aperture pivotally engaging the bolt;
a toggle first condition wherein the longitudinal axis of the cylindrical body is coplanar to the longitudinal axis of the bolt;
a toggle second condition wherein the longitudinal axis of the cylindrical body is perpendicular to the longitudinal axis of the bolt;
a nut selectively engaging the cylindrical body in a toggle first condition, the nut located on the bottom end of the bolt; and
means for selectively securing the cylindrical body in a toggle first condition located between the head end of the bolt and the cylindrical body.

2. The fastener device of claim 1 wherein means for selectively securing the cylindrical body in a toggle first condition located between the head end of the bolt and the cylindrical body is a torus-shaped first O-ring having a diameter about the same as the toggle diameter.

3. The fastener device of claim 1 wherein means for selectively securing the cylindrical body in a toggle first condition located between the head end of the bolt and the cylindrical body is a torus-shaped first O-ring having a diameter about the same as the toggle diameter, a length of foam material selectively inserted into at least one of the toggle first opening and second opening, and a washer having about the same diameter as the diameter of the toggle and engaging the bolt on the same side of the toggle as the first O-ring, the washer nearer to the toggle than the first O-ring, and further wherein the nut has a parallelepiped protrusion, the nut positioned on the opposite side of the toggle from the first O-ring and the washer, the nut engaging one of the first opening and the second opening.

4. The fastener device of claim 1 wherein the nut further comprises a crescent-shaped first notch on a first top edge of the nut and an second notch on an opposite second top edge, respectively, the first notch and second notch selectively engaging the toggle.

5. The fastener device of claim 1 wherein the nut further comprises a crescent-shaped first notch on a first top edge of the nut, the first notch selectively engaging one of the toggle first opening and second opening.

6. The fastener device of claim 1 further comprising a cap having a shank end engaging the bolt bottom end and an opposite cutter end operationally engaging a drill bit, the cap having the same diameter as the toggle.

7. The fastener device of claim 1 wherein the bolt is a combination round head bolt.

8. The fastener device of claim 1 wherein the bolt is an eye bolt.

9. The fastener device of claim 2 wherein the bolt is a combination round head bolt.

10. The fastener device of claim 2 wherein the bolt is an eye bolt.

11. The fastener device of claim 3 wherein the bolt is a combination round head bolt.

12. The fastener device of claim 3 wherein the bolt is an eye bolt.

13. The fastener device of claim 4 wherein the bolt is a combination round head bolt.

14. The fastener device of claim 4 wherein the bolt is an eye bolt.

15. The fastener device of claim 5 wherein the bolt is a combination round head bolt.

16. The fastener device of claim 5 wherein the bolt is an eye bolt.

17. The fastener device of claim 6 wherein the bolt is a combination round head bolt.

18. The fastener device of claim 6 wherein the bolt is an eye bolt.

19. A method of using a fastener device comprising the steps of:
utilizing a fastener device comprising:
a bolt having a bottom end and a head end;
a toggle having a cylindrical body less than the bolt length, a diameter slightly greater than the diameter of the bolt, and a hollow interior, the body further comprising:
a first end having a U-shaped first opening running continuously along one side of the body, the first opening having a rounded first apex portion, and
a second end having a U-shaped second opening running continuously along the opposite side of the body from the first opening, the second opening having a rounded second apex portion;
the first apex portion and second apex portion forming an aperture through the center diameter of the body, the aperture pivotally engaging the bolt;
a toggle first condition wherein the longitudinal axis of the cylindrical body is coplanar to the longitudinal axis of the bolt;
a toggle second condition wherein the longitudinal axis of the cylindrical body is perpendicular to the longitudinal axis of the bolt;
a nut selectively engaging the cylindrical body in a toggle first condition, the nut located on the bottom end of the bolt; and
means for selectively securing the cylindrical body in a toggle first condition located between the head end of the bolt and the cylindrical body;
selectively positioning the means for selectively securing the cylindrical body in a toggle first condition;
positioning the toggle in a toggle first condition wherein the longitudinal axis of the cylindrical body is coplanar to the longitudinal axis of the bolt;
drilling the device through an item and through the drywall, thereby creating a hole no larger in diameter than the diameter of the toggle;
opening the cylindrical body on the back side of the drywall; and
tightening the device, thereby securing the cylindrical body flat against the back side of the drywall and the bolt head flush against the drywall.
